(19) United States
(12) Patent Application Publication
(10) Pub. No.: US 2011/0270673 A1
(43) Pub. Date: Nov. 3, 2011

(54) LOCATION-BASED ADVERTISEMENT CONVERSIONS

(75) Inventors: Jennifer W. Lin, Mountain View, CA (US); Anita Krishnakumar, San Mateo, CA (US); Ravi Jain, Palo Alto, CA (US)

(73) Assignee: GOOGLE INC., Mountain View, CA (US)

(21) Appl. No.: 12/771,589

(22) Filed: Apr. 30, 2010

(51) Int. Cl. G06Q 30/00; G06F 17/30; G01S 19/42

(52) U.S. Cl. 705/14.45; 342/357.25; 707/758; 707/E17.014

(57) ABSTRACT

In general, this specification relates to content presentation. One aspect of the subject matter described in this specification can be embodied in methods that include the actions of presenting one or more content items to a user, each content item being associated with a conversion location; logging an identifier for each of the one or more content items presented to the user; receiving a location and user identifier from the user; using the user identifier to identify the one or more content items presented to the user and comparing, using one or more processors, the location to the conversion location of the one or more content items presented to the user; and logging a conversion for a particular presented content item having a conversion location matching the received location. Other embodiments of this aspect include corresponding systems, apparatus, and computer program products.

### BACKGROUND

This instant specification relates to content presentation.

Advertisers provide advertisements in different forms in order to attract consumers. An advertisement (“ad”) is a piece of information designed to be used in whole or in part by a user, for example, a particular consumer. Ads can be provided in electronic form. For example, online ads can be provided as banner ads on a web page, as ads presented with search results, or as ads presented in a mobile application.

One can refer to the inclusion of an ad in a medium, e.g., a web page or a mobile application, as an impression. An advertising system can include an ad in a web page, for example, in response to one or more keywords in a user search query input to a search engine. If a user selects the presented ad (e.g., by “clicking” the advertisement), the user is generally taken to another location associated with the ad, for example, to another, particular web page.

A particular user action associated with an ad can be referred to as a conversion. A conversion can be online or offline. An example of an offline conversion is when a user views an ad online for a particular product and then purchases the item at an offline retail store.

### SUMMARY

In general, this specification relates to content presentation.

In general, one aspect of the subject matter described in this specification can be embodied in methods that include the actions of presenting one or more content items to a user, each content item being associated with a conversion location; logging an identifier for each of the one or more content items presented to the user; receiving a location and user identifier from the user; using the user identifier to identify the one or more content items presented to the user and comparing, using one or more processors, the location to the conversion location of the one or more content items presented to the user; and logging a conversion for a particular presented content item having a conversion location matching the received location. Other embodiments of this aspect include corresponding systems, apparatus, and computer program products.

These and other embodiments can optionally include one or more of the following features. The content item can be an advertisement. Logging the one or more content items presented to the user includes mapping presented content items to a unique identifier of the user's mobile device. Receiving a location and user identifier from the user includes receiving a GPS location from a user's mobile device and a device identifier corresponding to the mobile device. The method further includes associating a plurality of content items with corresponding conversion locations. The conversion location corresponds to GPS coordinates. The conversion location corresponds to a region surrounding particular GPS coordinates. The conversion location corresponds to a semantic location. The conversion location corresponds to a region surrounding a particular semantic location.

In general, one aspect of the subject matter described in this specification can be embodied in methods that include the actions of receiving at a mobile device, one or more content items, each content item being associated with a particular conversion location; storing an association between the received one or more content items and the conversion locations; determining, using one or more processors, whether a mobile device location matches a conversion location of a received content item; and sending conversion information to an content item system. Other embodiments of this aspect include corresponding systems, apparatus, and computer program products.

These and other embodiments can optionally include one or more of the following features. the content item is an advertisement. Determining includes periodically comparing locations associated with positions of the mobile device with the stored conversion locations. Sending conversion information further includes applying one or more criteria to determine when to send conversion information. The criteria includes a specified time period. The criteria includes a specified number of determined conversions. The conversion location corresponds to GPS coordinates. The conversion location corresponds to a region surrounding particular GPS coordinates. The conversion location corresponds to a semantic location. The conversion location corresponds to a region surrounding a particular semantic location.

Particular embodiments of the subject matter described in this specification can be implemented to realize one or more of the following advantages. Offline conversions can be estimated based on user's proximity to a conversion location associated with particular content (e.g., an ad).

The details of one or more embodiments of the invention are set forth in the accompanying drawings and the description below. Other features, objects, and advantages of the invention will be apparent from the description and drawings, and from the claims.

### BRIEF DESCRIPTION OF THE DRAWINGS

FIG. 1 is a block diagram of an example advertising system.

FIG. 2 is a block diagram of an example advertising system for identifying offline ad conversions.

FIG. 3 is a flow diagram of an example process for identifying an offline ad conversion.

FIG. 4 is a block diagram of an example advertising system for identifying offline ad conversions.

FIG. 5 is a flow diagram of an example process for identifying an offline ad conversion.

Like reference symbols in the various drawings indicate like elements.

### DETAILED DESCRIPTION

Users can be presented with content items (e.g., ads). Content items can be displayed in various forms on a user device (e.g., a mobile phone, PDA, desktop computer). Different ways in which the user interacts with the content item can be counted as a conversion. For example, the user can click on the content item to reach a particular landing page, the user can buy a product from the landing page, or the user can interact with the content item in other ways. These conversion can be tracked in order to, for example, charge advertisers for the conversion.

In some implementations, the location of the user in proximity with a location associated with a conversion is used in order to identify a conversion as occurring. For example, a conversion can be inferred based on the GPS location of a mobile device matched to a location associated with a content item previously presented to the user of the mobile device. While reference will be made below to advertising systems and methods, other forms of content including other forms of sponsored content can be managed, presented, and tracked in accordance with the description below.

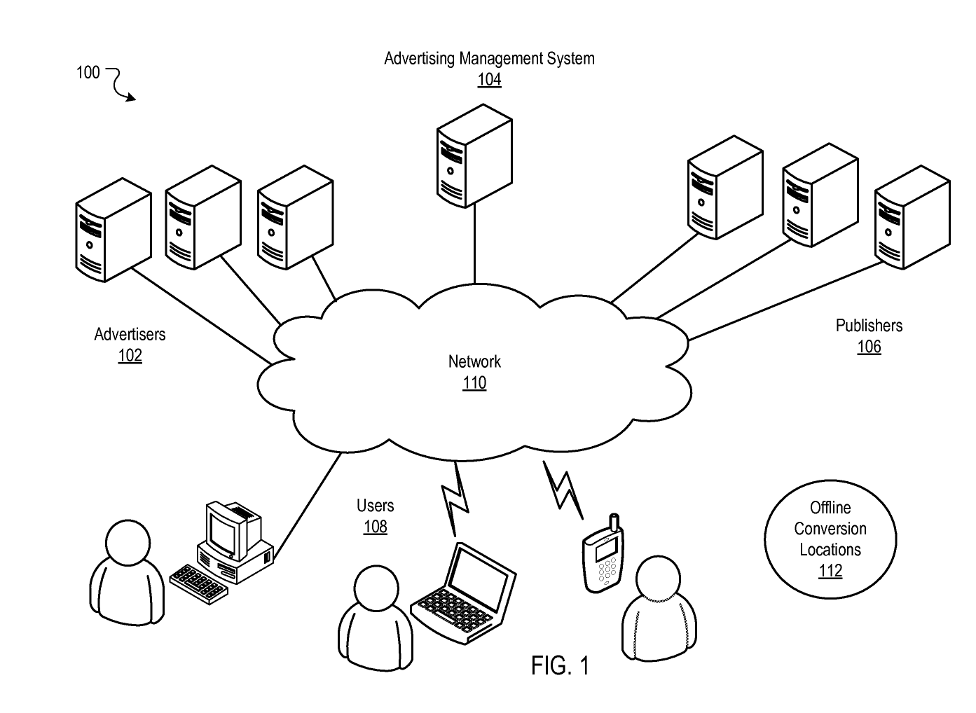

FIG. 1 is a block diagram of an example advertising system 100. In some implementations, one or more advertisers 102 can directly, or indirectly, enter, maintain, and track ad information in an advertising management system 104. Though reference is made to advertising, other forms of content, including other forms of sponsored content, can be delivered by the system 100. The ads can be in the form of graphical ads, such as banner ads, text only ads, image ads, barcode ads, audio ads, video ads, ads combining one or more of any of such components, etc. The ads can also include embedded information, such as links, meta-information, and/or machine executable instructions.

One or more publishers 106 can submit requests for ads to the system 104. The system 104 responds by sending ads to the requesting publisher 106 for placement on or association with one or more of the publisher's content items (e.g., web properties). Example web properties can include web pages, television and radio advertising slots, or print media space.

Other entities, such as users 108 and the advertisers 102, can provide usage information to the system 104, such as, for example, whether or not a conversion (e.g., a purchase or other interaction) or click-through related to an ad has occurred. This usage information can include measured or observed user behavior related to ads that have been served. The system 104 can perform financial transactions, such as crediting the publishers 106 and charging the advertisers 102 based on the usage information.

A network 110, such as a local area network (LAN), wide area network (WAN), the Internet, one or more telephony networks, or a combination thereof, connects the advertisers 102, the system 104, the publishers 106, and the users 108.

One example publisher 106 is a general content server that receives requests for content (e.g., articles, discussion threads, music, video, graphics, search results, web page listings, information feeds, etc.), and retrieves the requested content in response to the request. The content server can submit a request for ads to an advertisement server in the system 104. The ad request can include a number of ads desired. The ad request can also include content request information. This information can include the content itself (e.g., page, video broadcast, radio show, or other type of content), a category corresponding to the content or the content request (e.g., arts, business, computers, arts-movies, arts-music, etc.), part or all of the content request, content age, content type (e.g., text, graphics, video, audio, mixed media, etc.), geo-location information, etc.

In some implementations, the content server or a client browser can combine the requested content with one or more of the ads provided by the system 104. The combined content and ads can be sent/rendered to the users 108 that requested the content for presentation in a viewer (e.g., a browser or other content display system). The content server can transmit information about the ads back to the advertisement server, including information describing how, when, and/or where the ads are to be rendered (e.g., in HTML or JavaScript™)

Another example publisher 106 is a search service. A search service can receive queries for search results. In response, the search service can retrieve relevant search results from an index of resources (e.g., from an index of web pages). Search results can include, for example, lists of web page titles, snippets of text extracted from those web pages, and hypertext links to those web pages, and can be grouped into a predetermined number of (e.g., ten) search results.

The search service can submit a request for ads to the system 104. The request can include a number of ads desired. This number can depend on the search results, the amount of screen or page space occupied by the search results, the size and shape of the ads, etc. The request for ads can also include the query (as entered or parsed), information based on the query (such as geo-location information, whether the query came from an affiliate and an identifier of such an affiliate), and/or information associated with, or based on, the search results. The information can include, for example, identifiers related to the search results (e.g., document identifiers or “docIDs”), scores related to the search results (e.g., information retrieval (“IR”) scores), snippets of text extracted from identified documents (e.g., web pages), full text of identified documents, feature vectors of identified documents, etc. In some implementations, IR scores can be computed from, for example, dot products of feature vectors corresponding to a query and a document, page rank scores, and/or combinations of IR scores and page rank scores, etc.

In some implementations, the advertisement management system 104 includes an auction process to select ads from the advertisers 102. For example, the advertisers 102 can be permitted to select, or bid, an amount the advertisers are willing to pay for each presentation of or interaction with (e.g., click) of an ad, e.g., a cost-per-click amount an advertiser pays when, for example, a user clicks on an ad. The cost-per-click can include a maximum cost-per-click, e.g., the maximum amount the advertiser is willing to pay for each click of an ad based on a keyword, e.g., a word or words in a query. Other bid types, however, can also be used. Based on these bids, ads can be selected and ranked for presentation.

The search service can combine the search results with one or more of the ads provided by the system 104. This combined information can then be forwarded to the users 108 that requested the content. The search results can be maintained as distinct from the ads, so as not to confuse the user between paid ads and presumably neutral search results.

In some implementations, one or more publishers 106 can submit requests for ads to the advertising management system 104. The system 104 responds by sending ads to the requesting publisher 106 for placement on one or more of the publisher's web properties (e.g., websites and other network-distributed content) that are relevant to the web property. For example, if a publisher 106 publishes a sports-related web site, the advertising management system can provide sports-related ads to the publisher 106. In some implementations, the requests can instead be executed by devices associated with the user 108, e.g., by the execution of a javascript when the publisher's web page is loading on a client device.

Another example publisher 106 is a mobile application developer. A mobile application is an application specifically designed for operation on a mobile device (e.g., a smartphone). The mobile application can also include ads positioned within the content of the mobile application. Similarly to publishers 106, the ads can be received from the system 104 for placement in the mobile application when accessed by a user (e.g., when a particular page of a mobile application is loaded on the mobile device).

In some implementations, offline conversions can occur e.g., at offline locations 112. A conversion can be a user action of interest to the advertiser (e.g., making a purchase). Advertisers can measure the effectiveness of advertising campaigns based on the conversions that occur relative to the presented advertisements. However, if a user 108 views an ad on a device and then travels to a store to make a purchase, it can be difficult to link the conversion to the advertisement.

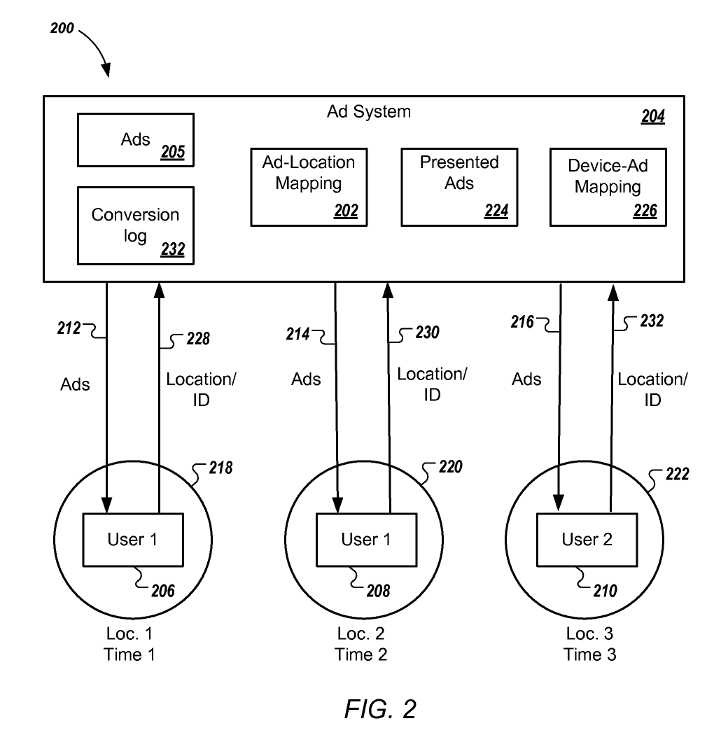

FIG. 2 is a block diagram of an example advertising system 200 for identifying offline ad conversions. The advertising system 200 includes an ad repository 205, ad-location mapping 202, ad logs 224, device-ad mapping 226, and conversion logs 232. Users 206, 208, and 210 can interact with the ad system 200 to receive ads and to provide location information to the ad server 200.

The advertising system 200 can select one or more ads from the advertisement repository 305 and send the selected advertisements (e.g., ads 212-216) to respective users 206-210. The conversion logs 232 record conversion events. Online conversion events can include selecting an ad or other interaction with the ad, and user activity on a landing page of the advertiser (e.g., a page presented to the user in response to a user selected ad) including filling out forms or purchasing items (e.g., from a specific conversion page). Conversions can also be offline, for example, a purchase of an advertised item at a physical store. In some implementations, the conversion logs 232 record online conversions, offline conversions, or both.

Ad-location mapping 202 associates ads with conversion locations. The conversion locations are particular geographic locations identified as being associated with a conversion for a particular ad. A conversion location can be defined, for example, by GPS (Global Positioning Satellite) coordinates (e.g., latitude and longitude), address locations, or a region surrounding particular GPS coordinates. A region can be defined as an area within a particular distance (e.g., one hundred feet) of particular GPS coordinates. As another example, a conversion location can be a semantic location or a region surrounding a semantic location. A semantic location can be, for example, a shopping mall, a park, a landmark, or some other area of interest. Since one dimension (e.g., width) of a semantic location area such as a shopping mall can be a distance of several hundred feet (or several city blocks), particular GPS coordinates can be considered to be in a region surrounding a semantic location if the GPS coordinates represent a location within a certain distance (e.g., one hundred feet) outside of a boundary of the semantic area. Thus, for each conversion location the ad-location mapping identifies the corresponding ad or ads with that location.

The ad logs 224 identify ads presented to each user. The ad logs can include an identifier of each individual ad, a timestamp for the ad delivery, as well as one or more identifier for the user (e.g., a device identifier, a user account, etc.). The device-ad mapping 226 associates ads with particular user devices (e.g., user mobile phones). Specifically, the device-ad mapping 226 identifies the ads that are associated with a particular user device. The device-ad mapping 226 can be part of the ad logs 224. Thus, the mappings can be used to identify a location and device associated with a particular ad.

The users 206, 208, and 210 can represent, for example, different users at different locations, different locations for the same user, or a combination of both. For example, the user 206 can represent a first user at a first point in time at a first location 218 and the user 208 represents the first user at a second point in time at a second location 220. Additionally, the user 210 can represent a different, second user at a third point in time at a third location 222. Some or all of the locations 218-222 can correspond to offline conversion locations for particular ads (e.g., offline conversion locations 112). For example, the second location 220 and the third location 222 can be offline conversion locations (e.g., offline conversion location 112) while the first location 218 can be a location which is not an offline conversion location 112.

Each of the advertisements 212-216 presented to the users can have one or more associated offline conversion locations 112. For example, the advertisement 212 sent to the user 206 can be associated with the second location 220 (e.g., where the second location 220 is an offline conversion location 112). Additionally, users can send information to the ad system including a location and an identifier 228-232 of the respective user 206-210.

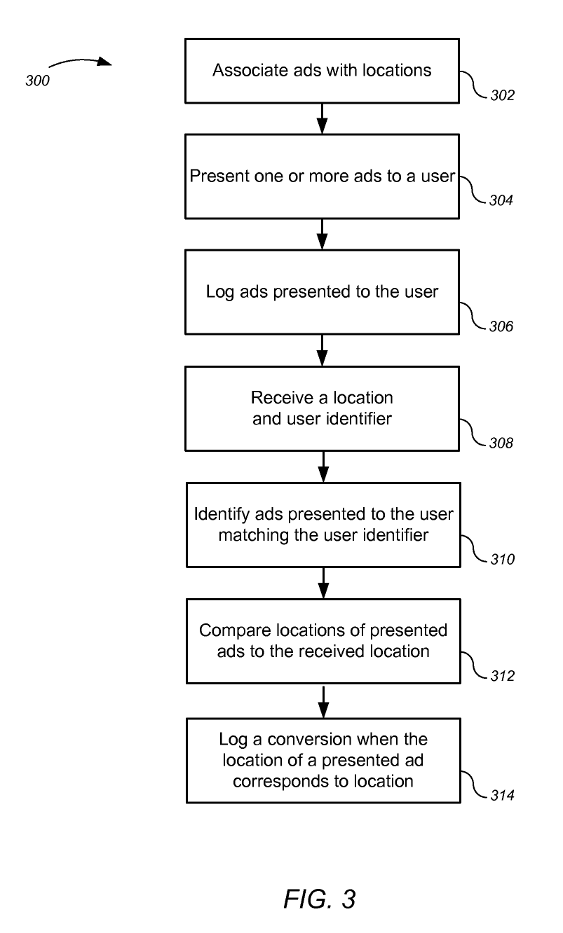

FIG. 3 is a flow diagram of an example process 300 for logging a location-based advertisement conversion. The process 300 can, for example, be implemented in an advertising system such as the online advertising system 100 of FIG. 1 or the advertising system 200 of FIG. 2.

Ads are associated with locations (302). For example, in reference to FIG. 1, an advertiser 102 can associate an advertisement with one or more offline conversion locations 112 in the advertising management system 102. An offline conversion location 112 can be, for example, a location where a user can purchase a product featured in an advertisement. The ads can be mapped to conversion locations by an ad-location mapping (e.g., ad-location mapping 202) of an advertising system.

One or more ads are presented to a user (304). Ads can be presented to a user (or candidate ads identified for selection) based on the geographic location of the user, the user's interests, keywords of a search query entered by the user, or based on content of a document (e.g., web page) being viewed by the user, to name a few examples. Additionally, particular ads from candidate ads can be selected according to an auction or other selection process. For example and in reference to FIG. 1, one or more ads can be presented to one or more users 108, such as in association with content from a publisher 106 displayed on a mobile device of a user 108.

For example, the advertising system can select one or more advertisements from an advertisement repository (e.g., advertisement repository 205) and can send selected ads (e.g., ads 212-216) to one or more users (e.g., users 206-210).

Ads presented to the user are logged (306). For example, advertisements presented to one or more users can be logged by the advertisement system (e.g., based on an ad identifier). The ads presented to the users can be logged in an ads log (e.g., ad logs 224) and mapped to the respective users based on a device-ad mapping (e.g., device-ad mapping 226). Information logged in the ads log can include, for example, for each logged advertisement, an advertisement identifier (e.g., advertisement title, advertisement number), a creative or advertising group identifier, an advertisement campaign identifier, a device identifier of a mobile device to which the advertisement was presented, and a timestamp indicating when the advertisement was presented on the mobile device.

A device identifier can be, for example, a unique alphanumeric identifier associated with the mobile device, or can be a username of the user of the mobile device. A device identifier stored in the ads log can be obfuscated for privacy reasons. For example, a stored identifier can be a random identifier derived from an actual device identifier, or a stored identifier can be an encrypted version of a device identifier.

A location and user and/or device identifier are received (308). For example, a GPS location from a user's mobile device and a device identifier corresponding to the mobile device can be received. Location and device information can be sent from a mobile device of the user to the advertising system. The location and device information can include, for example, location information (e.g., GPS coordinates) representing the first location and a device identifier identifying the mobile device of the user.

Location and device information can be periodically sent by the user's device (e.g., once per minute, every five minutes). Alternatively, the information can be sent not based on time but on location. For example, the location and device information can be sent from the mobile device of the user at a first point in time when the user is at a first location, and updated location information and device information can be sent at a second point in time when the user can be at a second location (e.g., as represented by user).

The location and device information can include the same information as the location and device information if, for example, the mobile device of the user has not moved during the time period between the first point in time and the second point in time. In some implementations, a frequency of sending of location and device information can be lessened if it is determined that the user's mobile device has not moved for a certain period of time (e.g., the user may be sitting in their office or the mobile device might not be in possession of the user (e.g., the mobile device may be on a nightstand or in a parked car). For example, if a user's mobile device has not moved for thirty minutes, a sending frequency can change from once a minute to once every five minutes (e.g., to conserve device power). If it is subsequently determined that a user's mobile device location has changed, a frequency can be increased (e.g., from once every five minutes to once every minute).

In some implementations, the location and device information is sent when the mobile device of the user detects that the mobile device has been at the same location for at least a threshold number of minutes (e.g., ten). Similarly, the information can be updated if the mobile device detects that the mobile device has moved to and has stayed at a new location for at least the threshold amount of time (e.g., a specified number of minutes).

Ads presented to the user and matching the user identifier are identified (310). For example, the advertising system can match a user's logged location with a location corresponding to a presented ad. For example, in response to receiving the location and device information, the device-ad mapping can parse the device identifier of the mobile device of the user from the location and device information and can query the ad logs to identify ads presented to mobile devices having the same identifier as the mobile device of the user. For example, information in the ads log 224 corresponding to advertisements 212 and 214 can be identified as being sent to the mobile device of the first user 208. In some implementations, ads presented to the user within a certain number of days (e.g., thirty) can be identified where ads with an associated presentation date older than a certain date (e.g., a date older than thirty dates from the present date) are not identified.

Locations of presented ads are compared to the received location (312). Specifically, the received location of the user can be compared with locations associated with the identified user ads according to an ad-location mapping (e.g., ad-location mapping 202). In some implementations, the user location matches an ad location if it is within a specified distance (e.g., within x feet) to provide flexibility in matching user locations to ad locations.

A conversion is logged when the location of a presented ad corresponds to the received location (314). The advertising system can determine that the location associated with an ad presented to a user corresponds to the location for the device such that the ad system can log a conversion as having occurred (e.g., using conversion log 232). In some implementations, the conversion is recorded or stored for later use by the ad system.

In some implementations, a conversion is associated with the received location and with multiple advertisements. For example, the advertising system can send multiple advertisements to a user for different products offered by the same retail store. The advertising system can identify the multiple advertisements as being associated with a location visited by the first user and can log a conversion in the conversions log which includes information identifying the multiple advertisements.

In some implementations, even if the location of the user device is identified as matching a location of an ad presented to the user, a conversion may not be logged until other conditions are satisfied. For example, a particular amount of time spent at the conversion location, or within a specified range of the conversion location, (e.g., 10 minutes) can be required to identify a conversion. Thus, the likelihood that an actual conversion has occurred can be increased by differentiating between a user that spends time at a conversion location (e.g., at a store) as opposed to simply passing by the store.

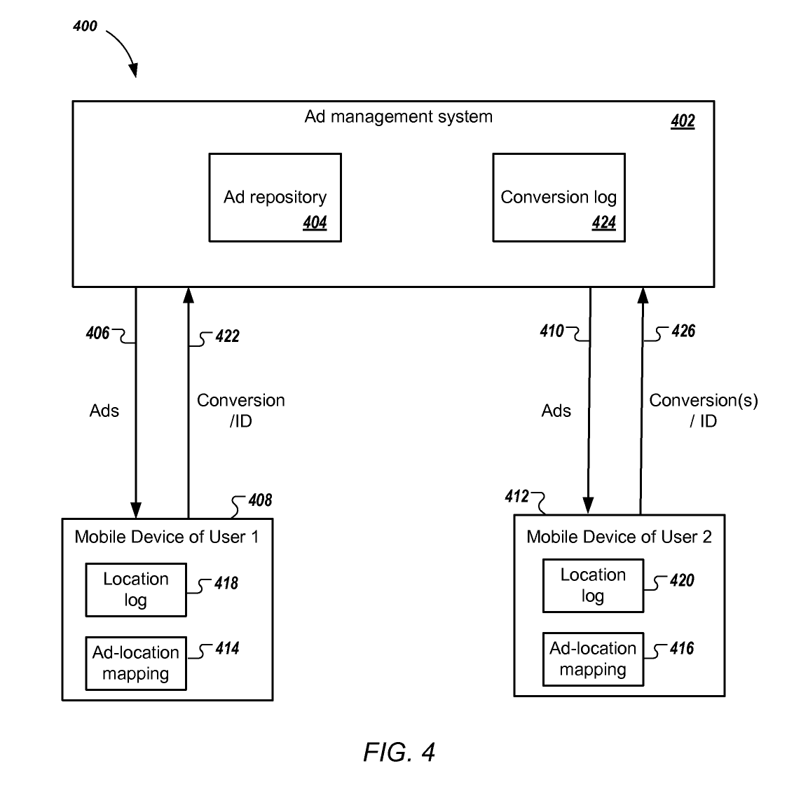

FIG. 4 is a block diagram of an example advertising system 400 for identifying offline ad conversions. The advertising system 400 includes an ad management system 402 and mobile users 508 and 512. The ad management system 402 includes an ads repository 404 and conversion logs 424. In contrast to the advertising system 200 of FIG. 2, an ad-location mapping 414 is located on the mobile device of the user. Specifically, mobile device 408 includes location log 418 and ad-location mapping 414. Similarly, mobile device 420 includes location log 420 and ad-location mapping 416. The ad management system 402 sends ads 406, 410 to the mobile devices 408, and 412, respectively, for presentation to users. The mobile devices send conversion indicators and ad identifiers 422, 426 to the ad management system 402 in order to record conversions associated with ad locations as identified by the mobile devices.

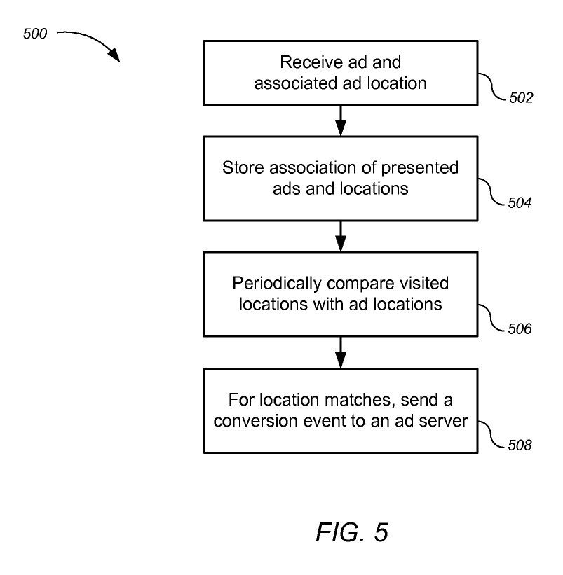

FIG. 5 is a flow diagram of an example process 500 for logging an offline advertisement conversion. The process 500 can, for example, be implemented in a system such as the online advertising system 100 of FIG. 1 or the advertising system 400 of FIG. 4.

One or more ads, each having an associated conversion location is received (502). For example, a mobile device of a user can receive one or more ads and associated ad conversion location from an advertising management system (e.g., the advertising management system 402). Ads can be presented to a user based on the geographic location of the user, the user's interests, keywords of a search query entered by the user, or based on content of a document (e.g., web page) being viewed by the user, to name a few examples.

For example, the advertising management system can select one or more advertisements from an ad repository (e.g., ad repository 404), and can send one or more selected ads to a mobile device of a user. The advertisements can include associated conversion location information for one or more offline conversion locations (e.g., offline conversion locations 112), for example, the conversion location identifies one or more locations where a product targeted in an advertisement can be purchased.

An association of presented advertisements and locations is stored (504). For example, an association between the received ads and their respective conversion locations can be stored on the device in an ad-location mapping (e.g., ad-location mapping 414). In some implementations, the mobile device stores information for the advertisements in the ad-location mapping for a specified time period (e.g., thirty days) after the ads have been received and can delete the information for the advertisements after the specified time period has elapsed.

Mobile device locations are periodically compared with advertisement locations (506). For example, a mobile device can periodically compare location information representing one or more positions of the mobile device to one or more conversion locations associated with respective ads presented on the mobile device. Both device locations and conversion locations can refer to GPS coordinates, a region surrounding particular GPS coordinates, a semantic location (e.g., shopping mall), or a region surrounding a particular semantic location. The mobile device can detect, for example, that the mobile device is at a same physical location for more than a threshold amount of time (e.g., ten minutes). For example, the mobile device can detect that the location of the mobile device has not changed by more than a threshold distance (e.g., two hundred feet) for the threshold amount of time around a particular location coordinate (e.g., if the user is walking around in a store, the user's location can change slightly).

For example, locations visited by the mobile device can be stored in a locations log included in the mobile device (e.g., a locations log 418). The mobile device can, on a periodic basis (e.g., hourly, daily), compare locations stored in the locations log to offline conversion locations associated with received ads stored on the mobile device. As another example, in response to determining that the mobile device has remained in a same location for a threshold amount of time (e.g., ten minutes), the mobile device can compare the detected location to offline conversion locations associated with received ads stored on the mobile device.

A conversion event is sent to an advertising management system when a mobile device locations matches a conversion location for an ad (508). For example, in response to determining that a location of the mobile device matches a conversion location associated with a received ad, a mobile device can send a conversion event which identifies the mobile device and the ad to the advertising management system. As another example, the mobile device can send a batch of conversion events to the advertising management system. For example, the mobile device can (e.g., to save battery power), send a batch of conversion events to the advertising management system after a threshold number of conversion events (e.g., five) have occurred. As another example, the mobile device can periodically (e.g., daily) send a batch of conversion events to the advertising management system that includes information for conversion events occurring during a particular time period. If no conversion events have occurred during the time period, the mobile device may not send any information to the advertising management system for that time period.

The mobile device can, in response to a determined location match, send a conversion event to the advertising management system. The conversion event can include, for example, an identifier of the associated matched ad, an identifier of the mobile device, and a timestamp. The advertising management system can store information from the conversion event in a conversion log (e.g., conversion log 418). Information from the conversion log can be used in managing financial transactions between the advertising system and the advertiser associated with the ad conversion.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on a computer storage media for execution by, or to control the operation of, data processing apparatus. The computer storage medium can be, or be included in, a computer-readable storage device, a computer-readable storage substrate, a random or serial access memory array or device, or a combination of one or more of them.

The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, or declarative or procedural languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described is this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any implementation or of what may be claimed, but rather as descriptions of features that may be specific to particular embodiments of particular implementations. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Particular embodiments of the subject matter described in this specification have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

What is claimed:

1. A method comprising:
presenting one or more content items to a user, each content item being associated with a conversion location;
logging an identifier for each of the one or more content items presented to the user;
receiving a location and user identifier from the user;
using the user identifier to identify the one or more content items presented to the user and comparing, using one or more processors, the location to the conversion location of the one or more content items presented to the user; and
logging a conversion for a particular presented content item having a conversion location matching the received location.

2. The method of claim 1, where the content item is an advertisement.

3. The method of claim 1, where logging the one or more content items presented to the user includes mapping presented content items to a unique identifier of the user's mobile device.

4. The method of claim 1, where receiving a location and user identifier from the user includes receiving a GPS location from a user's mobile device and a device identifier corresponding to the mobile device.

5. The method of claim 1, further comprising:
associating a plurality of content items with corresponding conversion locations.

6. The method of claim 1, where the conversion location corresponds to GPS coordinates.

7. The method of claim 1, where the conversion location corresponds to a region surrounding particular GPS coordinates.

8. The method of claim 1, where the conversion location corresponds to a semantic location.

9. The method of claim 1, where the conversion location corresponds to a region surrounding a particular semantic location.

10. A method comprising:
receiving at a mobile device, one or more content items, each content item being associated with a particular conversion location;
storing an association between the received one or more content items and the conversion locations;
determining, using one or more processors, whether a mobile device location matches a conversion location of a received content item; and
sending conversion information to an content item system.

11. The method of claim 10, where the content item is an advertisement.

12. The method of claim 10, where determining includes periodically comparing locations associated with positions of the mobile device with the stored conversion locations.

13. The method of claim 10, where sending conversion information further comprises applying one or more criteria to determine when to send conversion information.

14. The method of claim 13, where the criteria includes a specified time period.

15. The method of claim 13, where the criteria includes a specified number of determined conversions.

16. The method of claim 10, where the conversion location corresponds to GPS coordinates.

17. The method of claim 10, where the conversion location corresponds to a region surrounding particular GPS coordinates.

18. The method of claim 10, where the conversion location corresponds to a semantic location.

19. The method of claim 10, where the conversion location corresponds to a region surrounding a particular semantic location.

20. A system comprising:
a user device; and
one or more computers operable to interact with the device and operable to perform operations comprising:
presenting one or more content items to a user, each content item being associated with a conversion location;
logging an identifier for each of the one or more content items presented to the user;
receiving a location and user identifier from the user;
using the user identifier to identify the one or more content items presented to the user and comparing the location to the conversion location of the one or more content items presented to the user; and
logging a conversion for a particular presented content item having a conversion location matching the received location.

21. The system of claim 20, where the content item is an advertisement.

22. The system of claim 20, where logging the one or more content items presented to the user includes mapping presented content items to a unique identifier of the user's mobile device.

23. The system of claim 20, where receiving a location and user identifier from the user includes receiving a GPS location from a user's mobile device and a device identifier corresponding to the mobile device.

24. The system of claim 20, further operable to perform operations comprising:
associating a plurality of content items with corresponding conversion locations.

25. The system of claim 20, where the conversion location corresponds to GPS coordinates.

26. The system of claim 20, where the conversion location corresponds to a region surrounding particular GPS coordinates.

27. The system of claim 20, where the conversion location corresponds to a semantic location.

28. The system of claim 20, where the conversion location corresponds to a region surrounding a particular semantic location.

29. A system comprising:
one or more processors configured to perform operations comprising:
receiving at a mobile device, one or more content items, each content item being associated with a particular conversion location;
storing an association between the received one or more content items and the conversion locations;
determining whether a mobile device location matches a conversion location of a received content item; and
sending conversion information to an content item system.

30. The system of claim 29, where the content item is an advertisement.

31. The system of claim 29, where determining includes periodically comparing locations associated with positions of the mobile device with the stored conversion locations.

32. The system of claim 29, where sending conversion information further comprises applying one or more criteria to determine when to send conversion information.

33. The system of claim 32, where the criteria includes a specified time period.

34. The system of claim 32, where the criteria includes a specified number of determined conversions.

35. The system of claim 29, where the conversion location corresponds to GPS coordinates.

36. The system of claim 29, where the conversion location corresponds to a region surrounding particular GPS coordinates.

37. The system of claim 29, where the conversion location corresponds to a semantic location.

38. The system of claim 29, where the conversion location corresponds to a region surrounding a particular semantic location.

39. A computer storage medium encoded with a computer program, the program comprising instructions that when executed by data processing apparatus cause the data processing apparatus to perform operations comprising:
presenting one or more content items to a user, each content item being associated with a conversion location;
logging the one or more content items presented to the user;
receiving a location and user identifier from the user;
using the user identifier to identify the one or more content items presented to the user and comparing the location to the conversion location of the one or more content items presented to the user; and
identifying a conversion for a particular presented content item having a conversion location matching the received location.

40. A computer storage medium encoded with a computer program, the program comprising instructions that when executed by data processing apparatus cause the data processing apparatus to perform operations comprising:
receiving at a mobile device, one or more content items, each content item being associated with a particular conversion location;
storing an association between the received one or more content items and the conversion locations;
determining whether a mobile device location matches a conversion location of a received content item; and
sending conversion information to an content item system.
